(19) United States
(12) Patent Application Publication
(10) Pub. No.: US 2008/0282262 A1
(43) Pub. Date: Nov. 13, 2008

(54) AUTOMATIC AND CONFIGURABLE LOADING OF LOOSELY COUPLED SERVICE ORIENTED SOFTWARE COMPONENTS

(75) Inventor: Georgios Chrysanthakopoulos, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/747,178

(22) Filed: May 10, 2007

(51) Int. Cl. G06F 9/46

(52) U.S. Cl. 719/316

(57) ABSTRACT

An apparatus and method provide for providing services using an attribute. In one example, the attribute may hide complexity of an underlying infrastructure and may call methods in the infrastructure to locate partner services. Any number of partner services may include a policy in which a pre-existing instance of a partner service may be used to perform desired services. Alternatively, an instance of a service may be created. In another example, a manifest in a partner list entry may be used for identifying a set of services at a node.

### BACKGROUND

In the management of services, a message is typically received at a service and the service may become activated responsive to the received message. However, access to services have typically been difficult and cumbersome, particularly when multiple services are coordinated. For example, one service may need functionality of another service to respond to a request. The first service would need to access or communicate with the other service before responding to a request message from a client. Also, the other service may, in turn, need to access or communicate with yet another service before responding to the first service. For each of the services, each may have corresponding identifiers such as Uniform Resource Identifiers (URIs). Accessing certain backend services may be problematic as it may be required that a user hack through layers of services to expose the desired service.

Also, such a network of services may result in high complexity. A typical user desires easy and convenient access to services to accomplish tasks of interest. However, users are typically overwhelmed with the excessive and confusing instructions, changing of protocols, complex connectors, and the like in attempting to accomplish even simple tasks. Thus, there is a need for accessing and deploying services simply and efficiently.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

In one example, a method is described for providing a service in which a message may be received and method may be called from an infrastructure for identifying a partner service. A service may include a software component loosely coupled from other components by using messages. The messages may be exchanged over a network, for example, or within an Operating System (OS) process. Also, an attribute may be provided for calling methods and/or for indicating a status of the services.

In another example, a method is described for identifying a service and/or a policy associated with the service. Also, the identified service may be deployed based on the policy. An attribute may further be received for accessing methods in an infrastructure or identifying services.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 illustrates an example of a suitable computing system environment.

FIG. 2 illustrates an example of a network of services.

FIG. 3 illustrates an example of an attribute through which methods in an infrastructure may be executed.

FIG. 4 is a flowchart illustrating an example of using an existing instance of a service.

FIG. 5 is a flowchart illustrating another example of using an existing instance of a service.

FIG. 6 is a flowchart illustrating an example of a process for creating an instance of a service for executing a function.

FIG. 7 is a flowchart illustrating an example of a process for determining behavior of a service.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples. Systems described herein are provided as examples and not limitations. As those skilled in the art will appreciate, the present examples are suitable for application in a variety of different types of computing systems.

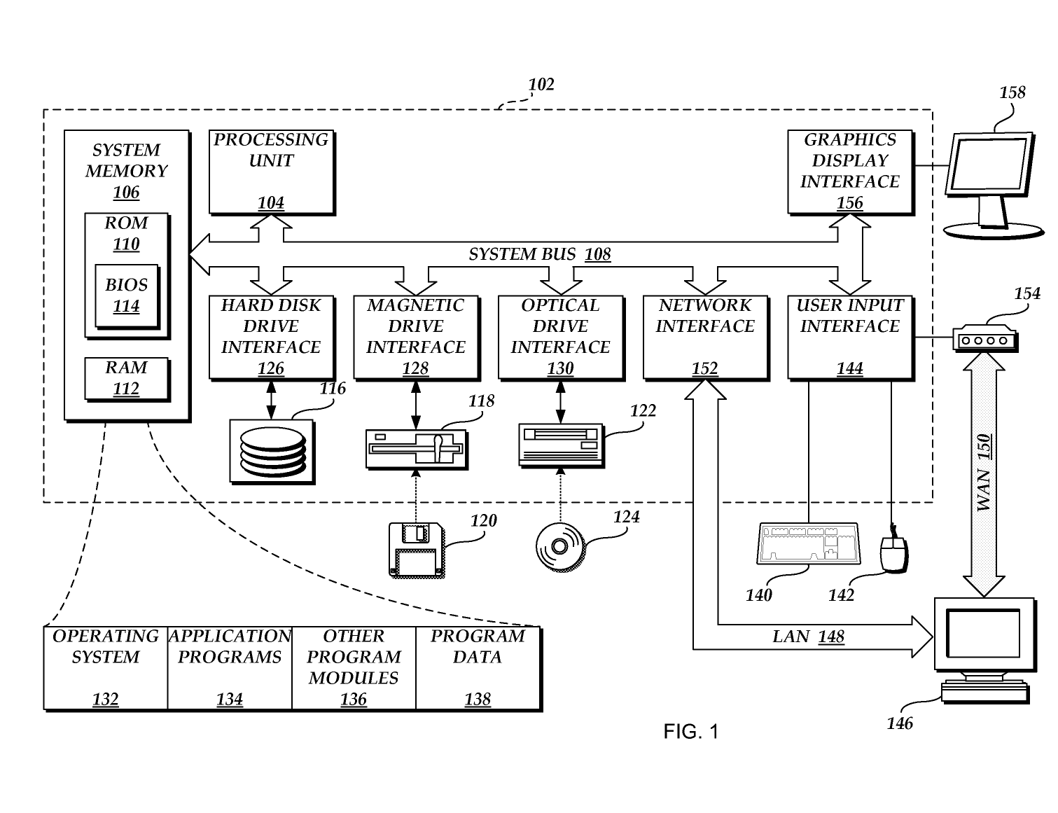

FIG. 1 illustrates an example of a suitable computing system environment or architecture in which computing subsystems may provide processing functionality. The computing system environment is only one example of a suitable computing environment and is not intended to suggest any limitation as to the scope of use or functionality of the invention. Neither should the computing environment be interpreted as having any dependency or requirement relating to any one or combination of components illustrated in the exemplary operating environment.

The method or system disclosed herein is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The method or system may be described in the general context of computer-executable instructions, such as program modules, being executed by a computer. Generally, program modules include routines, programs, objects, components, data structures, etc. that perform particular tasks or implement particular abstract data types. The method or system may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the method or system includes a general purpose computing device in the form of a computer 102. Components of computer 102 may include, but are not limited to, a processing unit 104, a system memory 106, and a system bus 108 that couples various system components including the system memory to the processing unit 104. The system bus 108 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 102 typically includes a variety of computer readable media. Computer readable media can be any available media that can be accessed by computer 102 and includes both volatile and nonvolatile media, removable and non-removable media. By way of example, and not limitation, computer readable media may comprise computer storage media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 102. Combinations of the any of the above should also be included within the scope of computer readable storage media.

The system memory 106 includes computer storage media in the form of volatile and/or nonvolatile memory such as read only memory (ROM) 110 and random access memory (RAM) 112. A basic input/output system 114 (BIOS), containing the basic routines that help to transfer information between elements within computer 102, such as during start-up, is typically stored in ROM 110. RAM 112 typically contains data and/or program modules that are immediately accessible to and/or presently being operated on by processing unit 104. By way of example, and not limitation, FIG. 1 illustrates operating system 132, application programs 134, other program modules 136, and program data 138.

The computer 102 may also include other removable/non-removable, volatile/nonvolatile computer storage media. By way of example only, FIG. 1 illustrates a hard disk drive 116 that reads from or writes to non-removable, nonvolatile magnetic media, a magnetic disk drive 118 that reads from or writes to a removable, nonvolatile magnetic disk 120, and an optical disk drive 122 that reads from or writes to a removable, nonvolatile optical disk 124 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 116 is typically connected to the system bus 108 through a non-removable memory interface such as interface 126, and magnetic disk drive 118 and optical disk drive 122 are typically connected to the system bus 108 by a removable memory interface, such as interface 128 or 130.

The drives and their associated computer storage media discussed above and illustrated in FIG. 1, provide storage of computer readable instructions, data structures, program modules and other data for the computer 102. In FIG. 1, for example, hard disk drive 116 is illustrated as storing operating system 132, application programs 134, other program modules 136, and program data 138. Note that these components can either be the same as or different from additional operating systems, application programs, other program modules, and program data, for example, different copies of any of the elements. A user may enter commands and information into the computer 102 through input devices such as a keyboard 140 and pointing device 142, commonly referred to as a mouse, trackball or touch pad. Other input devices (not shown) may include a microphone, joystick, game pad, pen, scanner, or the like. These and other input devices are often connected to the processing unit 104 through a user input interface 144 that is coupled to the system bus, but may be connected by other interface and bus structures, such as a parallel port, game port or a universal serial bus (USB). A monitor 158 or other type of display device is also connected to the system bus 108 via an interface, such as a video interface or graphics display interface 156. In addition to the monitor 158, computers may also include other peripheral output devices such as speakers (not shown) and printer (not shown), which may be connected through an output peripheral interface (not shown).

The computer 102 may operate in a networked environment using logical connections to one or more remote computers, such as a remote computer. The remote computer may be a personal computer, a server, a router, a network PC, a peer device or other common network node, and typically includes many or all of the elements described above relative to the computer 102. The logical connections depicted in FIG. 1 include a local area network (LAN) 148 and a wide area network (WAN) 150, but may also include other networks. Such networking environments are commonplace in offices, enterprise-wide computer networks, intranets and the Internet.

When used in a LAN networking environment, the computer 102 is connected to the LAN 148 through a network interface or adapter 152. When used in a WAN networking environment, the computer 102 typically includes a modem 154 or other means for establishing communications over the WAN 150, such as the Internet. The modem 154, which may be internal or external, may be connected to the system bus 108 via the user input interface 144, or other appropriate mechanism. In a networked environment, program modules depicted relative to the computer 102, or portions thereof, may be stored in the remote memory storage device. By way of example, and not limitation, remote application programs may reside on a memory device. It will be appreciated that the network connections shown are exemplary and other means of establishing a communications link between the computers may be used.

Any number of services may be executing concurrently in a computing environment. A service may include any software component loosely coupled from other components by using messages, either over a network, for example, or over an OS process. In one example, a service includes a web service but may include any number or type of such services. For example, services may function in an infrastructure that may run services concurrently. Concurrently running services in a concurrency infrastructure may be facilitated with an overlying attribute for indicating characteristics of the concurrency. Also, processes or services in the concurrency infrastructure may be performed via a queue, process and/or behavior. In one example of a CONST service, a message such as a GET message may be received at a service or system. Responsive to receiving the GET message, the service may return a CONST value.

The attribute may implement any number or type of policies corresponding to execution and provision of services. The following is one example of an attribute that enumerates partner service creation. This is merely one example of policies provided via the attribute as any relevant information pertaining to the provision of services may be provided in the attribute:

```
    /// <summary>
    /// Enumeration specifying partner service creation policy
    /// </summary>
    [DataContract]
    public enum PartnerCreationPolicy
    {
        /// <summary>
        /// Use an existing instance of the proper service type, from
the local directory.
        /// </summary>
        UsePartnerListEntry,
        /// <summary>
        /// Use an existing instance of the proper service type, from
the local directory.
        /// </summary>
        UseExisting,
        /// <summary>
        /// Use an existing instance of the proper service type, from
the local directory. If no instance
        /// is available, create one
        /// </summary>
        UseExistingOrCreate,
        /// <summary>
        /// Always create a new instance of the service
        /// </summary>
        CreateAlways
    }
```

As can be see above in this example, the attribute provides for a partner service creation policy in which a partner service may be identified for providing a desired service. A local directory may be accessed to determine if an instance of the desired partner service is available or present. If found, an existing instance of the partner service may be used (e.g., “use existing”). If not found, an instance of the desired partner service may be created (e.g., “use existing or create”). Also in this example, an existing instance of a service of the type corresponding to the desired partner service may be located and the instance of the service of that type may be used (e.g., “use partner list entry”). In addition, a new instance of the desired partner service may be created irrespective of the presence of an existing instance of the desired partner service (e.g., “create always”). Each of these examples are described more fully below.

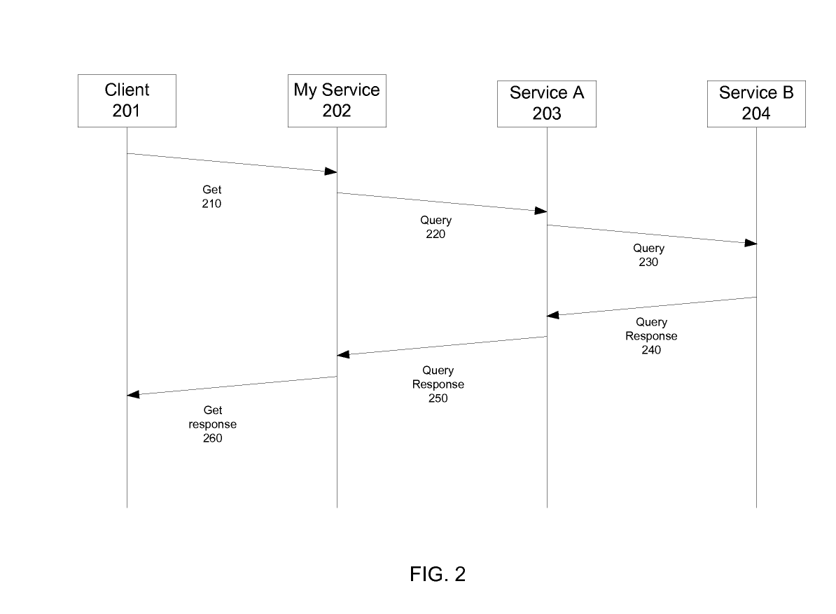

FIG. 2 illustrates an example of a network of services. A client 201 communicates with a service 202 by sending a message (e.g., a GET message 210). The service 202 receives the GET message 210 from the client 201 and returns a response 260 to the client 201. In this example, additional services are present and may execute certain processes responsive to the GET message 210 from the client 201. For example, Service A 203 and/or Service B 204 may be in communication with the service 202 for providing a desired function or service. Also in this example, each of the services (i.e., service 202, service A 203, and service B 204) may be considered as peer devices or systems. In addition, any of the services may have an associated Uniform Resource Identifier (URI). However, in one example, the URIs corresponding to service A 203 and/or service B 204 may be hidden from client 201. Thus, in this example, each of service 202, service A 203 and service B 204 are peers in a system of services with service 202 advertising services to client 201. Client 201 may access or send a message to service 201 (e.g., a GET message 210) to receive a response (e.g., GET response 260) or to perform a function or service.

Also, service 202 may further send a message to any other service such as service A 203 or service B 204 which may be hidden from client 201. In this example, service 202 may send a query 220 to service A 203 and may receive a query response 250 from service A 203 responsive to the query 220. Also, service A 203 may further send a query 230 to another service such as service B 204 and may receive a query response 240 from service B 204 responsive to the query 230. After receiving the query response 240 from service B 204, service A 203 may return the query response 250 to service 202. The service 202 may receive the query response 250 from service A 203 and may return the GET response 260 to client 201.

The services may be created in a factored manner. For example, service 202 may desire services from service A 203 and/or service B 204. Service 202 may desire access to an instance of, for example, service A 203 but may not desire a specific instance of service A 203. Thus, the instance of service A 203 may be located at any network site. Service 202 may call any relevant methods from an underlying concurrency infrastructure such that service A 203 may locate a partner service, such as service B 204 at runtime.

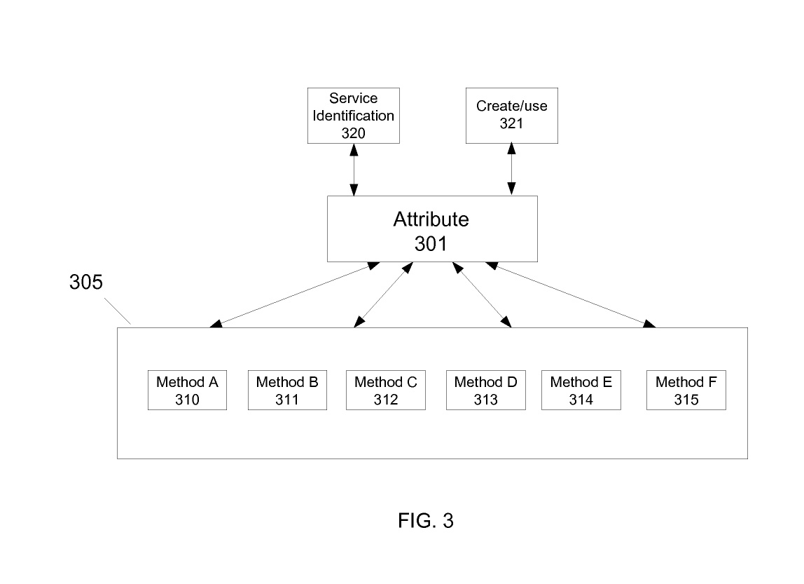

In another example, an attribute may be generated through which relevant methods in a runtime infrastructure may be performed for executing any number or type of services. FIG. 3 illustrates an example of an attribute through which methods in an infrastructure may be executed. In this example, an infrastructure 350, such as a concurrency infrastructure, may be implemented for performing any number of services or for locating or identifying instances of a service. For example, a first service may desire information from a second service or may wish to access the second service. The first service may locate any instance of the second service (e.g., a partner service) by execution of the infrastructure 350. The infrastructure may include any number of methods for executing a desired function or service. FIG. 3 illustrates the infrastructure 350 has having method A 310, method B 311, method C 312, method D 313, method E 314, and method F 315. However, any number or type of methods may be incorporated in the infrastructure 350.

In one example, a service may be located by execution of one or more of the methods (310-315) in the infrastructure 350. Any of the methods may be executed at runtime. In another example, an attribute 301 may be included and hooked up to the infrastructure 350. The attribute 301 may provide access to the methods (e.g., 310-315) of the infrastructure 350 and may call the methods (310-315) of the infrastructure 350 to perform a desired function. In this example, execution of one or more of the methods via the attribute 301 may locate a desired instance of a service in a network of services.

The instance of the desired service may include a URI corresponding to the instance. The URI of the instance may be provided via the attribute 301. In addition, the attribute 301 may further provide access to a port bound to the URI. A user may select a partner service and may further identify a policy or a partner creation policy. For example, a user may determine a need for a service. A partner creation policy may also be determined to identify a method of obtaining an instance of the desired service. A function or service may be performed based on whether an instance of partner service is found or not.

In one example, an attribute may be provided for locating a pre-existing instance of a service. In this example, an attribute may include a service identification 320 for identifying a desired service. Based on the service identification 320, the service and an instance of the service may be identified. The attribute 301 also includes a create/use component 321 for indicating a status of the instance of the service. In this case, the create/use component 321 may indicate that the instance of the desired service is pre-existing. In a “use existing” status in which the instance of the desired service is pre-existing, the instance may be used via a service forward in which a port may be returned based on a provided URI. Thus, a binding occurs with a queue in which the URI corresponding to the instance of the service is provided. Hence, in the use existing case of the present example, any instance of the service may be identified via the attribute and used for providing a function or service.

In another example, hook up to a single service may be requested. In this case, the attribute 301 may contact underlying methods (e.g., methods 310-315) of an infrastructure (e.g., infrastructure 350) for performing a function associated with the single service. The attribute 301 may further indicate availability or functionality of the service. For example, if the service is inoperable of if the service otherwise fails, the attribute may identify the service, determine the functionality or status of the service and determine to start the service based on the determined status or functionality. Hence, depending on the status of the service, the service may be activated or executed. Alternatively, based on the status, execution of the service may be aborted (e.g., the service fails).

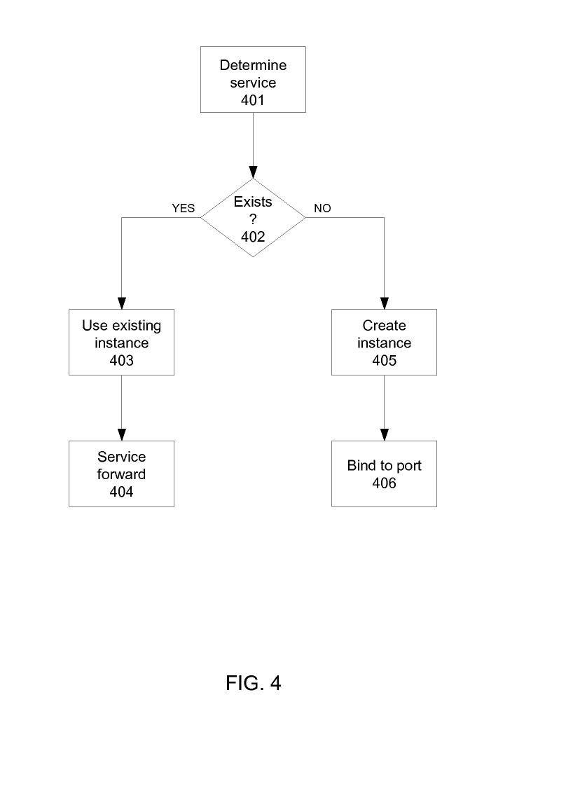

FIG. 4 is a flowchart illustrating an example of using an existing instance of a service. In this example, a service is identified (STEP 401). A client (e.g., client 201, FIG. 2) may send a message to a service to perform a desired function. The service may further access an instance of another service. A determination may be made if the instance of the other service exists (STEP 402). If the instance of the desired service exists and is located (“Yes” branch of STEP 402), the identified instance of the service is utilized (STEP 403) to execute the desired function. For example, if the instance of the service exists, a service forward may be performed (STEP 404) in which the service may provide a URI corresponding to the desired instance of the service and a port may be returned based on the URI provided. Thus, the service may complete a requested function after accessing another existing service.

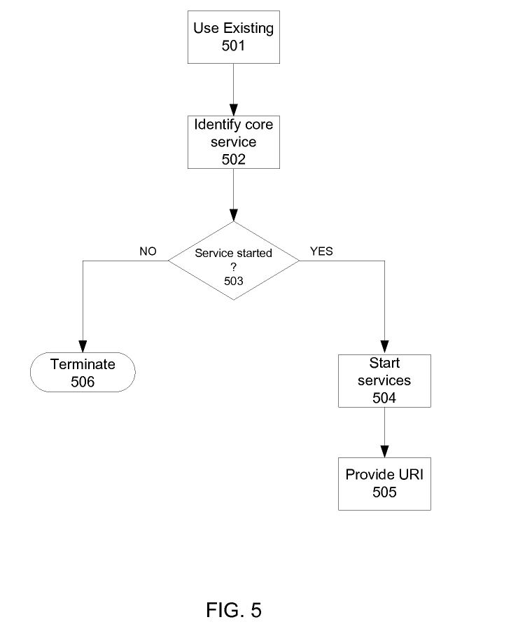

FIG. 5 is a flowchart illustrating another example of using an existing instance of a service (STEP 501). In this example, any number of services may be executing in combination to provide a desired function. In a group of such services, one service may be identified as a core service (STEP 502) such that the core service may indicate the functionality and/or status of the other services in the group of services. The core service may partner with any of the other services in the group of services such that the status of the core service may indicate the status of the other services in the group. For example, the status of the core service may be determined (STEP 503) as being started or not started. If the core service has started (“Yes” branch of STEP 503), then other services may be accessed and/or started, if desired (STEP 504). In this case, a URI corresponding to services may be provided (STEP 505) and the core service may identify a service from the group of the services based on the URI. Alternatively, if the core service has not started (“No” branch of STEP 503), the process may terminate (STEP 506) and a URI may not be provided.

Alternatively, the other service or an instance of the other service may not exist or may not be located by the first service (“No” branch of STEP 402, FIG. 4). In this case, an instance of the desired service may be created (STEP 405) in which the other service may be executed asynchronously via binding to a port (STEP 406). Any of the actions may be accomplished via the attribute (e.g., attribute 301, FIG. 3).

In another example, an attribute may determine that an instance of a service may be created. For example, a requested URI corresponding to a desired service or an instance of the service may not be located. A constructor method in the infrastructure may be executed to create the desired instance of the service. Also, the service may be created of a particular type and the service may be executed asynchronously. In addition, calling of the method and execution of the method to create the service may be performed via the attribute.

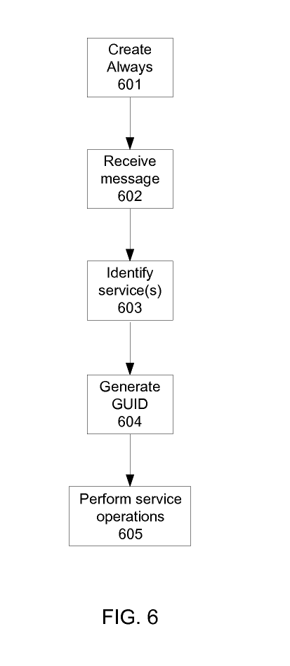

The service or instance of the service may be created (e.g., STEP 405, FIG. 4) such that the generated instance of the service is private to a user. FIG. 6 is a flowchart illustrating an example of a process for creating an instance of a service for executing a function. For example, any number of services may each contain an associated identifier (e.g., a GUID). An instance of a service may be created (STEP 601) such that a different identifier corresponding to the created service or instance of the server may be generated. A user connected to the instance of the service may have a private connection, if desired, such that the user is the only user connected or hooked up to the instance of the service.

For example, a service may receive a message from a client (STEP 602). The message may include, for example, a GET message and the service may return a response to the client responsive to the GET message. In this example, the service may desire access to another service prior to returning the response to the client. The service may therefore identify the other service (STEP 603), which may perform a function desired by the first service.

However, in this example, an instance of the desired other service may be created. An identifier, such as a GUID (STEP 604) may be generated corresponding to the service such that the client may be connected privately to the service. A corresponding service or function may be executed as desired (STEP 605).

One example of connecting to a private instance of a service includes a subscription service that maintains a subscription list. In this example, a user may subscribe to the subscription service. As a result of subscribing, the user may be added to a subscription list by the subscription service. The service may further update the subscriber list based on events or actions taken. For example, a person may unsubscribe or leave the service for any reason. In this case, the subscription service may update the information. In addition, the updating may be accomplished via an attribute as described above. In this case, the subscription service may receive a subscribe message, which may be forwarded via the underlying infrastructure.

In another example, behavior of a process or service may be modified at any of different stages. For example, behavior may be determined or modified at design time, at runtime or at deployment time. During design time, for example, an attribute may be included to specify behavior of a service. During runtime, for example, an instruction may be included in the attribute for identifying a service to execute at the time the process executes at runtime. Also, logic may be provided to select a service at runtime. Alternatively, behavior may be modified or determined during deployment time. In one example, behavior is determined or modified during deployment time using a partner list entry.

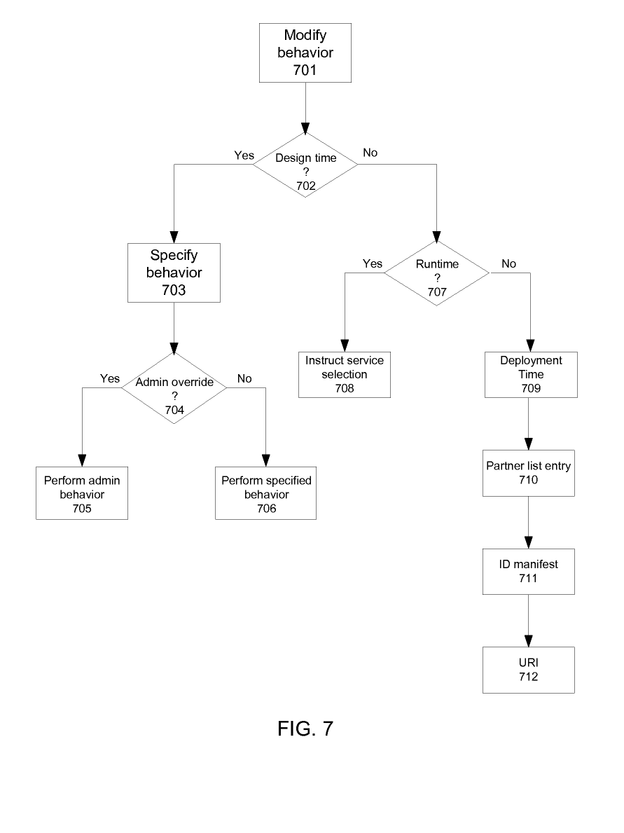

FIG. 7 is a flowchart illustrating an example of a process for determining behavior of a service (STEP 701). If identification of the behavior of the process is during design time (“Yes” branch of STEP 702), the behavior is specified, e.g., by a designer or developer (STEP 703). The behavior may be applied to the service (STEP 705) based on input from an administrator. If administrator override is not received (“No” branch of STEP 704), then the behavior applied to the service by the designer may be implemented (STEP 706). However, if an administrator override is received (“Yes” branch of STEP 704), then the override behavior may be performed (STEP 705). For example, a designer may configure a process or service to execute as specified. Also, a hierarchy of overrides may be implemented in which the overrides may be provided by an administrator. In this example, the administrator may outrank the developer such that the behavior specified by the administrator is executed instead of the behavior specified by the designer.

During runtime (“No” branch of STEP 702 and “Yes” branch of STEP 707), a developer may not previously know which services to execute during runtime. For example, during design time, the developer may not have information as to which services are available during runtime. In this case, an instruction may be provided to select a service at runtime (STEP 708).

During deployment time (“No” branch of STEP 707), a user may wish to deploy services in a particular configuration or with certain policies or security provisions in a deployment scenario, for example. A developer of the system may not know the specific deployment scenario at deployment time (STEP 709) for the user at design time and may use a partner list entry (STEP 710). The partner list entry may include a manifest (STEP 711), which is a mechanism to start a service. The manifest corresponding to the service may be identified (STEP 711) and may include, for example, a message and/or a file to permit reading any number of nodes when the node is started.

During deployment time, any of the services may include operation of any number or type of devices. Each device or group of devices may function in a different deployment. A URI corresponding to different deployments may be assigned to any deployment. The manifest may provide the URI (STEP 712) such that when the service starts, a URI is available from the manifest.

The attribute (e.g., attribute 301, FIG. 3) may include any number or type of parameter for indicating a policy pertaining to a partner service. For example, the attribute may include a parameter for indicating a “use existing” scenario in which an instance of a desired partner service is identified as pre-existing and the identified instance is used to perform a desired service. In one example, the attribute may include a class including the following:

[partner(partner creation policy. use existing)]

In this example, a partner service is identified in addition to a corresponding policy. In this case, the instance of the partner service is pre-existing such that the pre-existing instance of the service is accessed. In addition, the class may further include additional parameters for describing a behavior of a service. For example, the class may further include an “optional true” parameter for indicating that the identified service should be executed at runtime.

Alternatively, the attribute may include a parameter to indicate that a new instance of a partner service is to be created. For example, a class may include the following:

[partner(partner creation policy. create always. optional true)]

In this example, an instance of a partner service may be created and the created instance of the partner service may be executed to perform a desired function. In one example, an instance of the partner service is not found and a new instance is created responsive to the lack of identification of the pre-existing instance. In another example, an instance of the partner service may exist, however, a private instance of the partner service is desired. In this case, an instance of the partner service may be created (e.g., a different GUID) such that the requesting client or service may be the only client or service connected to the particular instance of the partner service.

Also, the attribute may include a parameter to indicate that a partner list entry may be used corresponding to a desired service. For example, a class may include the following:

[partner(partner creation policy. use partner list entry. optional true)]

In this example, a service may access a manifest in a partner list entry at deployment time. The manifest may include, for example, a message or file for indicating a set of services at a node. Hence, at deployment time, a system may be deployed in a particular deployment scenario. A URI may be set corresponding to the particular deployment scenario.

It is understood that aspects of the present description can take many forms and embodiments. The embodiments shown herein are intended to illustrate rather than to limit the description, it being appreciated that variations may be made without departing from the spirit of the scope of the invention. Although illustrative embodiments have been shown and described, a wide range of modification, change and substitution is intended in the foregoing disclosure and in some instances some features may be employed without a corresponding use of the other features. Accordingly, it is appropriate that the appended claims be construed broadly and in a manner consistent with the scope of the invention.

1. A method for managing services comprising:
receiving a message via an attribute from a client;
calling one or more methods from an infrastructure via the attribute;
identifying an instance of one or more partner services based on the one or more methods;
executing a service with the one or more partner services responsive to the message from the client.

2. The method of claim 1 wherein the attribute indicates a partner creation policy for providing the one or more partner services.

3. The method of claim 2 wherein identifying the instance of the one or more partner services comprises locating a pre-existing instance of the one or more partner services.

4. The method of claim 3 further including:
identifying a core service associated with the one or more partner services;
determining a status of the core service;
determining a URI corresponding to the one or more partner services based on the status of the core service.

5. The method of claim 4 wherein the status of the core service indicates the core services is started and the step of determining a URI includes determining the URI of the one or more partner services.

6. The method of claim 4 wherein the status of the core service indicates the core service is not started and the step of determining the URI includes not providing the URI.

7. The method of claim 2 wherein the partner creation policy of the attribute includes creating an instance of the one or more partner services, the identifying the instance of the one or more partner services comprising generating an identifier corresponding to the one or more partner services, the identifier corresponding to a new instance of the one or more partner services.

8. The method of claim 2 wherein the partner creation policy of the attribute includes providing a partner list entry.

9. The method of claim 8 wherein the partner list entry contains a manifest for starting the one or more partner services, the manifest including a message and provides a list of services at a node.

10. A method for providing a service comprising:
receiving an attribute;
accessing one or more methods responsive to the attribute;
identifying a service based on the one or more methods;
determining a policy associated with the identified service;
selecting an instance of the identified service based on the policy; and
deploying the identified service.

11. The method of claim 10 wherein the attribute hooks up to an infrastructure, the infrastructure including the one or more methods, the identifying including executing the one or more methods and identifying the service based on the executed one or more methods.

12. The method of claim 11 wherein the policy includes a portion for determining a status of the instance of the identified service.

13. The method of claim 12 wherein selecting the instance includes determining a pre-existing instance of the identified service, the method further comprising providing a function associated with the identified service based on the pre-existing instance.

14. The method of claim 13 further comprising identifying a core service and providing the function associated with the identified service only if the identified core service is started.

15. The method of claim 12 wherein selecting the instance includes creating an identifier corresponding to the identified service, the identifier associated with a new instance of the identified service.

16. The method of claim 15 wherein the new instance of the identified service is a private instance.

17. The method of claim 12 further comprising deploying the identified service, the deploying including identifying a partner list entry for determining one or more services.

18. The method of claim 17 wherein the partner list entry comprises a manifest including a list of the one or more services.

19. The method of claim 12 further comprising receiving an override command, wherein selecting the instance includes selecting the instance based on the override command.

20. The method of claim 12 wherein the instance of the identified service includes a URI corresponding to the identified service.
